(19) United States
(12) Patent Application Publication
(10) Pub. No.: US 2010/0012222 A1
(43) Pub. Date: Jan. 21, 2010

(54) SLEEVE FOR USE WITH A CONTAINER

(76) Inventors: John D. Richardson, IV, New York, NY (US); Joshua L. Riley, Yonkers, NY (US)

Correspondence Address: BROWN RUDNICK LLP, ONE FINANCIAL CENTER, BOSTON, MA, 02111, US

(21) Appl. No.: 12/358,799

(22) Filed: Jan. 23, 2009

Related U.S. Application Data
(60) Provisional application No. 61/081,875, filed on Jul. 18, 2008.

(51) Int. Cl. B67C 11/04

(52) U.S. Cl. 141/331

(57) ABSTRACT

A sanitary beverage system and apparatus is presented. The system includes a frustoconically shaped receptacle having a first aperture, a middle portion, and a second aperture to facilitate the transfer of a liquid between a beverage receptacle and a beverage container. The first aperture has a sufficient diameter to prevent contact between an aperture of the beverage container and a beverage receptacle, and the transfer of bacteria therewith. At least one portion of the housing of the frustoconically shaped receptacle is adapted to form a secure coupling with a beverage container.

### CROSS-REFERENCE TO RELATED APPLICATIONS

This patent application claims priority to U.S. Provisional Application Ser. No. 61/081,875, filed in the U.S. Patent and Trademark Office on Jul. 18, 2008 by Richardson et al., the entire contents of that application being incorporated herein by reference in its entirety.

### BACKGROUND

1. Technical Field

The present disclosure generally relates to the field of sanitary receptacles for use with beverage containers, and more particularly, to a sanitary beverage receptacle that is coupled to a beverage container to prevent contact between a beverage dispenser and a beverage container, and the transfer of bacteria therewith.

2. Description of the Related Art

A number of different devices are presently utilized in the beverage industry for sanitizing beverage containers from bacteria. For example, a reusable lid, which includes a flat cover plate to cover the rim of a beverage can, may be used to prevent dirt and insects from entering the can. In another example, a cover may be coupled to a beverage can via a rivet to protect the lip contact portion of the can from the accumulation of micro-bacteria. In yet another example, a drink container cover having a sanitary liner may be used to protect the rim of the container from debris and bacteria.

Although sanitary covers presently known in the art are suitable for protecting beverage containers from bacteria, these devices suffer from several drawbacks. For example, prior art sanitary covers are not designed to prevent contact and/or the transfer of micro-bacteria between a beverage dispenser and a beverage container during the step of dispensing the contents from the beverage dispenser. Specifically, these sanitary covers do not protect against contact and/or the transfer of bacteria between a beverage dispenser spigot and the rim of a beverage container. Further, users of such sanitary covers are required to manually remove these sanitary covers to allow for liquid to be filled and/or refilled into a beverage container.

Therefore, a need exists for sanitary covers that may be secured to beverage containers during the steps of filling and/or refilling liquids via beverage dispensers.

### SUMMARY

According to an aspect of the present disclosure, a sanitary beverage apparatus is presented. The sanitary beverage apparatus includes a frustoconically shaped receptacle for preventing contact between a beverage dispenser and a beverage container, and the transfer of bacteria therewith. The frustoconically shaped receptacle further includes a first aperture, a middle portion, and a second aperture.

According to another aspect of the present disclosure, a sanitary beverage apparatus is presented. The sanitary beverage apparatus includes a frustoconically shaped receptacle for preventing contact between a beverage dispenser and a beverage container, and the transfer of bacteria therewith. The frustoconically shaped receptacle further includes a first aperture, a middle portion, and a second aperture. The first aperture includes a perpendicular rim, and at least one portion of the housing of the frustoconically shaped receptacle is adapted to form a secure coupling with an aperture of the beverage container.

According to yet another aspect of the present disclosure, a sanitary beverage system is presented. The sanitary beverage system includes a frustoconically shaped receptacle having a first aperture, a middle portion, and a second aperture to facilitate the transfer of liquid between a beverage receptacle and a beverage container. The first aperture having a sufficient diameter to prevent contact between an aperture of the beverage container and the beverage receptacle, and the transfer of bacteria therewith. At least one portion of the housing of the frustoconically shaped receptacle is adapted to form a secure coupling with the beverage container.

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings as set forth below:

FIG. 1 is a perspective view of a sanitary beverage apparatus, according to the present disclosure;

FIG. 2 is a perspective view of an embodiment of a sanitary beverage apparatus, according to the present disclosure;

FIG. 3 is a side-view of an embodiment of a sanitary beverage apparatus, according to the present disclosure;

FIG. 4 is a perspective view of another embodiment of a sanitary beverage apparatus, according to the present disclosure;

FIG. 5 is a side-view of another embodiment of a sanitary beverage apparatus, according to the present disclosure;

FIG. 6 is a perspective view of yet another embodiment of a sanitary beverage apparatus, according to the present disclosure;

FIG. 7 is a perspective view of another embodiment of a sanitary beverage apparatus, according to the present disclosure;

FIG. 8 is a side-view of yet another embodiment of a sanitary beverage apparatus, according to the present disclosure;

FIG. 9 is a perspective view of another embodiment of a sanitary beverage apparatus, according to the present disclosure; and

FIG. 10 is a side-view of another embodiment of a sanitary beverage apparatus, according to the present disclosure.

### DETAILED DESCRIPTION OF EXEMPLARY EMBODIMENTS

The present disclosure generally relates to the field of sanitary receptacles for use with beverage containers, and more particularly, to a sanitary beverage receptacle that is coupled to a beverage container to prevent contact between a beverage dispenser and a beverage container, and the transfer of bacteria therewith.

In the discussion that follows, the term “contact” shall refer to any connection between a beverage dispenser and a beverage container. Examples of contact may include, but are not limited to, any direct, indirect, substantially direct, substantially indirect, and/or inadvertent connection between a beverage dispenser and a beverage container.

Reference will now be made in detail to exemplary embodiments of the present disclosure, which are illustrated in the accompanying figures. The same reference numbers in different drawings may identify the same or similar elements. In addition, the following detailed description does not limit the present disclosure.

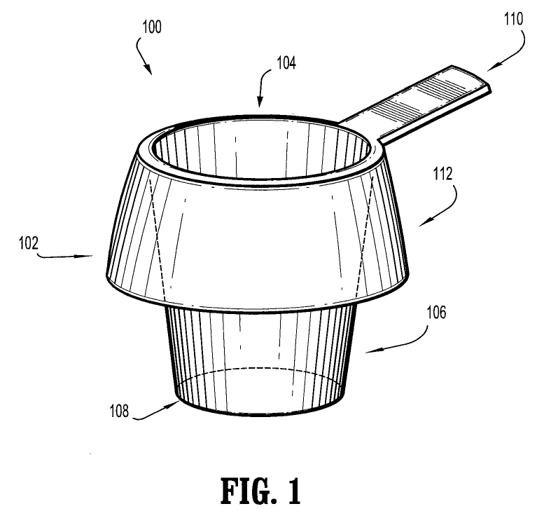

Referring to FIG. 1, a sanitary beverage apparatus 100 is presented. Apparatus 100 may include a receptacle 102, which is used to prevent contact between a beverage dispenser (not shown) and a beverage container (not shown), and the transfer of bacteria therewith. Examples of bacteria may include, but are not limited to, micro-organisms, viruses, micro-bacteria, germs, and the like. Receptacle 102 may be secured to the mouth of a beverage container to allow a beverage dispenser spigot to directly dispense liquids from the beverage dispenser without excessive spillage, contact, or the transfer of bacteria. It is contemplated that receptacle 102 may be any apparatus having at least one aperture. Examples of receptacles may include, but are not limited to, a conduit, a funnel, a cover, and the like.

Receptacle 102 may be suitable to use as a sanitary means of transferring a liquid between a beverage dispenser and a beverage container. Receptacle 102 may be comprised of one or more of the following materials: paper, plastic, foam, metal, molded fiber, wax, and the like. In an embodiment of the present disclosure, the paper may be, but is not limited to, a post consumer recyclable paper, a polyethylene coated paperboard, a biodegradable paper, and the like. In another embodiment, the plastic may be, but is not limited to, polyethylene terephthalate, high-density polyethylene, polyvinyl chloride, polypropylene, polystyrene, and the like. In yet another embodiment, the foam may be a polystyrene foam, such as stryofoam. In another embodiment, the metal may be, for example, an aluminum alloy. It is contemplated that a portion, including the inner and/or outer portions, or the entire housing of receptacle 102 may be comprised of, for example, anti-microbial materials, anti-bacterial materials, anti-septic materials, any combination thereof, and the like. It is further contemplated that receptacle 102 may be monolithically formed and/or disposable.

Receptacle 102 may include, but is not limited to, the following components: a first aperture 104, a middle portion 106, a second aperture 108, a portion 110, and an outer sleeve 112. Receptacle 102 may be, for example, any frustoconically shaped receptacle for use with a beverage container, such as a water bottle. It is contemplated that a water bottle may be, but is not limited to, Nalgene, Sigg, or other containers which provide a housing for any liquid.

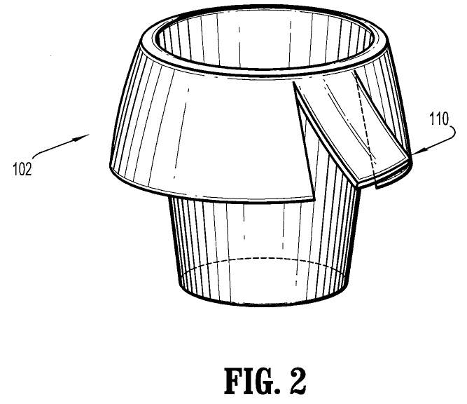

In an embodiment of the present disclosure, frustoconically shaped receptacle 102 may be coupled to the mouth of a beverage container. Receptacle 102 may be grasped by portion 110, which is affixed to the housing of first aperture 104 and projects outward from receptacle 102. Portion 110 may be provided to prevent contact and/or the transfer of bacteria from, for example, a hand of a person to the various components of receptacle 102. Further, portion 110 may be comprised of, but is not limited to, rigid materials such as rubber. Referring to FIG. 2, in an embodiment of the present disclosure, portion 110 may be comprised of semi-rigid and/or flexible materials to allow a user to attach portion 110 to the housing of receptacle 102 when not in use.

Referring now to FIG. 1, middle portion 106 of receptacle 102 may be inserted into the inner portion of the mouth of a beverage container. In another embodiment of the present disclosure, outer sleeve 112 may extend from middle portion 106 and provide an upwardly concave, down facing rim. Outer sleeve 112 may be configured to adapt and form a coupling with the outer portion of the mouth of a beverage container. It is contemplated that the coupling of outer sleeve 112 to an aperture of a beverage container may form a seal, a secure seal, a substantially secure seal, or no seal therewith. In another embodiment of the present disclosure, outer sleeve 112 may include indicia. Indicia may be, for example, any numeric, alphanumeric, or alphabetical text, graphical design, or any combination thereof. It is contemplated that indicia may be used for any purpose, including advertising.

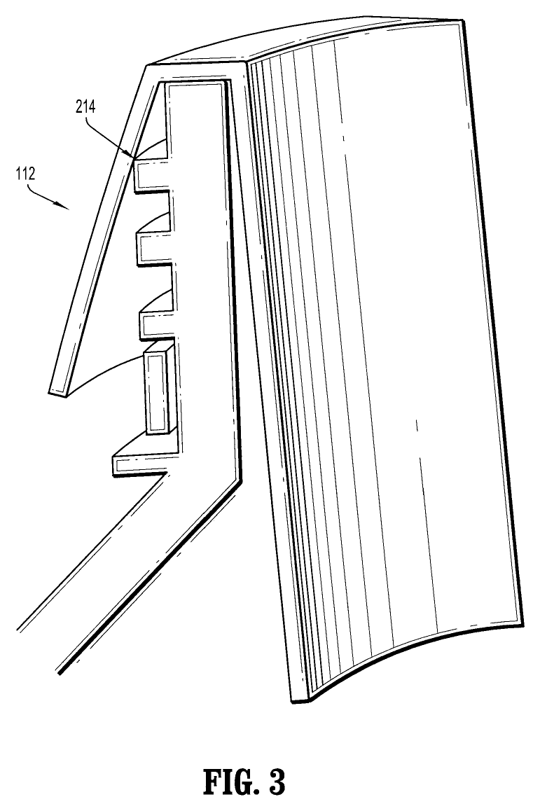

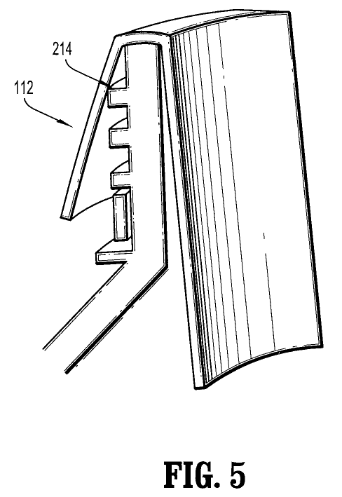

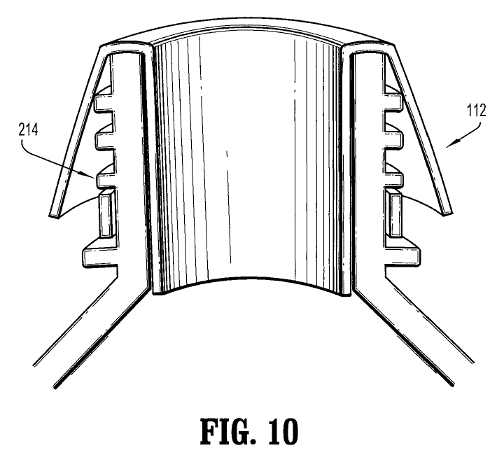

Referring to FIGS. 3, 5, and 10, in another embodiment of the present disclosure, outer sleeve 112 may be configured to engage at least one protruding piece 214 of the outer wall of the mouth of a beverage container via an interlocking means. Outer sleeve 112 may create an external barrier between the mouth of a beverage container and any portion of a beverage dispenser. This barrier provides a means to prevent contact and/or displace at least one bacterium that may be transferred from the beverage dispenser to the mouth of the beverage container and vice versa.

Referring now to FIG. 1, first aperture 104 may be configured to facilitate the transfer of a liquid from a beverage dispenser. In an embodiment of the present disclosure, first aperture 104 may have a sufficient diameter to allow for the insertion of a beverage dispenser spigot into the mouth of a beverage container having receptacle 102 associated thereto. Second aperture 108 may be configured to permit the transfer of liquids from a beverage dispenser spigot into a beverage container.

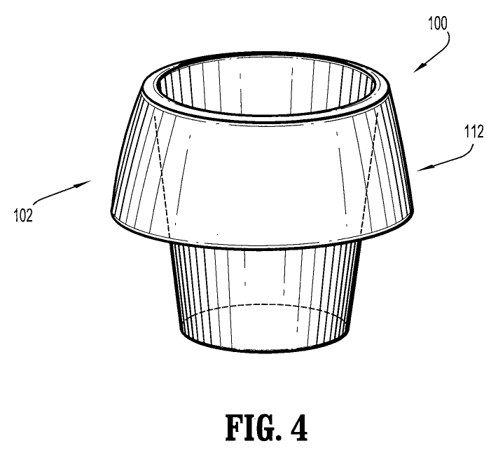

Referring to FIG. 4, another embodiment of sanitary beverage apparatus 100 is presented. In an embodiment of the present disclosure, outer sleeve 112 of receptacle 102 provides a rim with a downward sloping extension in contrast to the upwardly concave, down facing rim of outer sleeve 112 of FIG. 1. Receptacle 102 of FIG. 4 may function in a substantially identical manner as receptacle 102 of FIG. 1.

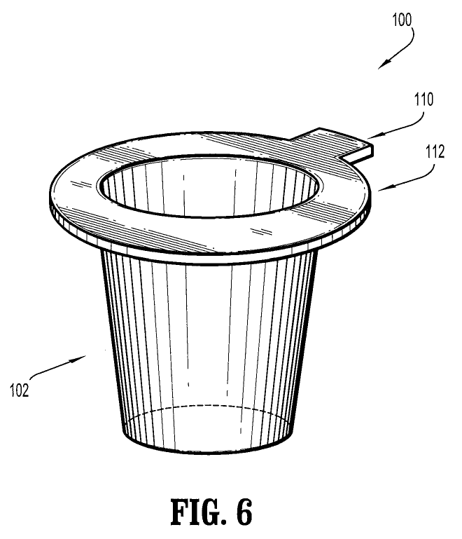

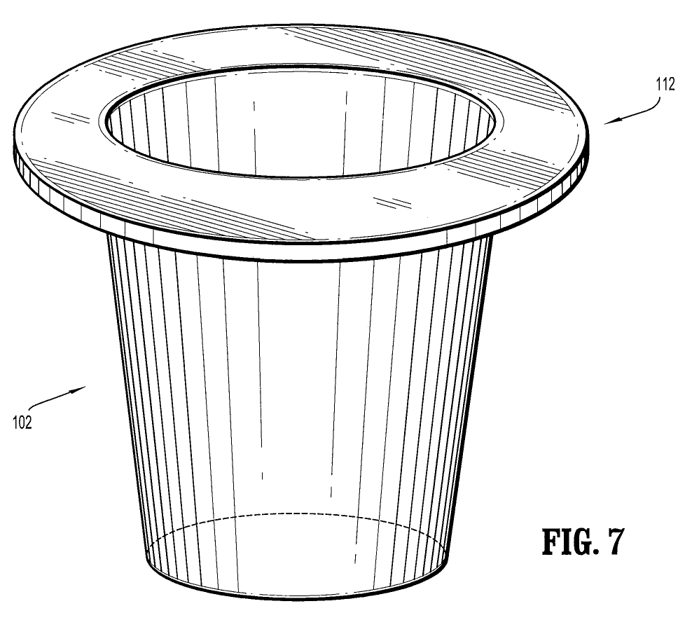

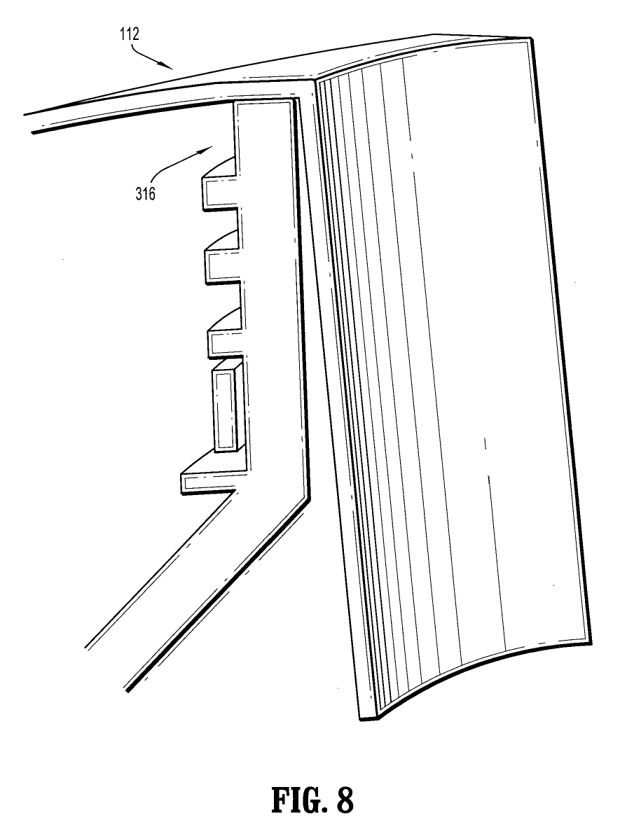

Referring to FIGS. 6 and 7, yet another embodiment of sanitary beverage apparatus 100 is presented. Apparatus 100 may include receptacle 102 having outer sleeve 112 and portion 110. Referring to FIG. 8, outer sleeve 112 may be configured to engage a top portion 316 of the outer wall of the mouth of a beverage container. Outer sleeve 112 may be coupled to top portion 316 of the beverage container. In an embodiment, the act of coupling the outer sleeve 112 to top portion 316 may form a seal between the beverage container and receptacle 102.

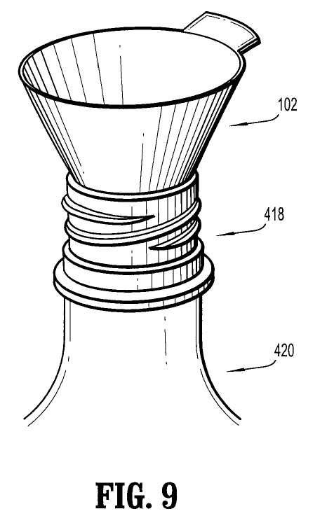

Referring to FIG. 9, an embodiment in which receptacle 102 may be coupled to a mouth 418 of a beverage container 420 is presented. In an embodiment of the present disclosure, beverage container 420 may be a water bottle and the beverage dispenser (not shown) may be a water dispenser having a spigot. A user may couple receptacle 102 to mouth 418 of beverage container 420 prior to dispensing a liquid from the spigot. In an embodiment, as beverage container 420 having the receptacle 102 associated thereto communicates with the spigot, receptacle 102 can prevent contact between the water dispenser spigot and an aperture of the water bottle. In another embodiment, the anti-microbial material of receptacle 102 can prevent and displace at least one bacteria residing on the water dispenser spigot. In yet another embodiment of the present disclosure, the anti-microbial material of receptacle 102 may further displace at least one bacteria residing on mouth 418 of beverage container 420.

It will be understood that various modifications may be made to the embodiments disclosed herein. Therefore, the above description should not be construed as limiting, but merely as exemplifications of the various embodiments of the present disclosure. Those skilled in the art will envision other modifications within the scope and spirit of the claims appended hereto.

What is claimed is:

1. A sanitary beverage apparatus comprising:
a frustoconically shaped receptacle for preventing contact between a beverage dispenser and a beverage container, and the transfer of bacteria therewith, the frustoconically shaped receptacle further comprising a first aperture, a middle portion, and a second aperture.

2. The apparatus of claim 1, wherein a semi-flexible portion is affixed to the first aperture.

3. The apparatus of claim 1, wherein the first aperture having an upwardly concave, down facing rim.

4. The apparatus of claim 1, wherein at least one portion of the housing of the frustoconically shaped receptacle is adapted to form a secure coupling with an aperture of the beverage container.

5. The apparatus of claim 1, wherein the frustoconically shaped receptacle is comprised of one or more of the following materials: a paper, a plastic, a foam, a metal, and a molded fiber.

6. The apparatus of claim 5, wherein the material is anti-microbial.

7. The apparatus of claim 6, wherein the anti-microbial material communicates and displaces at least one bacteria residing on an aperture of the beverage container.

8. The apparatus of claim 1, wherein the beverage dispenser is a water dispenser.

9. The apparatus of claim 1, wherein the beverage container is a water bottle.

10. The apparatus of claim 1, wherein the frustoconically shaped receptacle is disposable.

11. A sanitary beverage apparatus comprising:
a frustoconically shaped receptacle for preventing contact between a beverage dispenser and a beverage container, and the transfer of bacteria therewith, the receptacle further comprising a first aperture, a middle portion, and a second aperture, the first aperture having a perpendicular rim, and at least one portion of the housing of the frustoconically shaped receptacle is adapted to form a secure coupling with an aperture of the beverage container.

12. The apparatus of claim 11, wherein a semi-flexible portion is affixed to the first aperture.

13. The apparatus of claim 11, wherein the frustoconically shaped receptacle is comprised of one or more of the following materials: a paper, a plastic, a foam, a metal, and a molded fiber.

14. The apparatus of claim 13, wherein the material is anti-microbial.

15. The apparatus of claim 13, wherein the anti-microbial material communicates and displaces at least one bacteria residing on an aperture of the beverage container.

16. The apparatus of claim 11, wherein the beverage dispenser is a water dispenser.

17. The apparatus of claim 11, wherein the beverage container is a water bottle.

18. The apparatus of claim 11, wherein the frustoconically shaped receptacle is disposable.

19. The apparatus of claim 11, wherein the beverage dispenser is a water dispenser.

20. The apparatus of claim 11, wherein the perpendicular rim is a downward sloping rim.

21. A sanitary beverage system comprising:
A frustoconically shaped receptacle comprising a first aperture, a middle portion, and a second aperture to facilitate the transfer of a liquid between a beverage receptacle and a beverage container, the first aperture having a sufficient diameter to prevent contact between an aperture of the beverage container and the beverage receptacle, and the transfer of bacteria therewith, at least one portion of the housing of the frustoconically shaped receptacle is adapted to form a secure coupling with the beverage container.
